(19) United States
(12) Patent Application Publication
(10) Pub. No.: US 2011/0018379 A1
(43) Pub. Date: Jan. 27, 2011

(54) MAGNO-FORCE ENERGY. pdf

(76) Inventor: Prince MoronFolu Koye Adejumo, Ikeja (NG)

Correspondence Address: Prince M. Koye Adejumo, No. 3, Comfort Close, Ojodu Estate, Ojodu, Ikeja, Lagos, NG

(21) Appl. No.: 12/507,812

(22) Filed: Jul. 23, 2009

(51) Int. Cl. H02K 21/00; H02N 11/00

(52) U.S. Cl. 310/152; 415/916

(57) ABSTRACT

In the laws of magnet, apart from those of repelling and attracting terms, there's a third position hitherto unnoticed, that of rotating terms, when they are angular.

It is this 3^{rd} aspect that's been utilized to turn a wheel or cause a motion in a body.

The speed from the wheel is multiplied through a set of gear-wheels in order to turn an armature inside a coil. This generates electricity energy that can be applied as required.

Also, the spinning magnets that prompts the generation, or the electricity energy generated, when applied to run engines for vehicles, or supply homes and industries with power, does not leave an after-burn that can pollute the environment, the way the burning of fossil fuels does.

So, more importantly, it helps in redressing of global warming and attainment of a cleaner and greener world environment.

### SPECIFICATION AND DETAILED DESCRIPTION

### 001. Preamble and Theory

Prior to this moment, 2 laws of magnet were known to us.

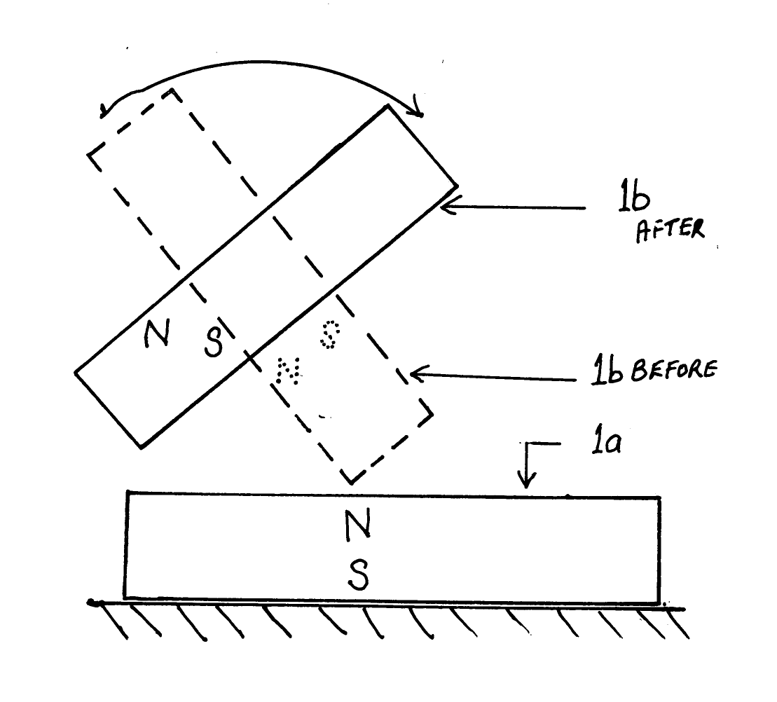

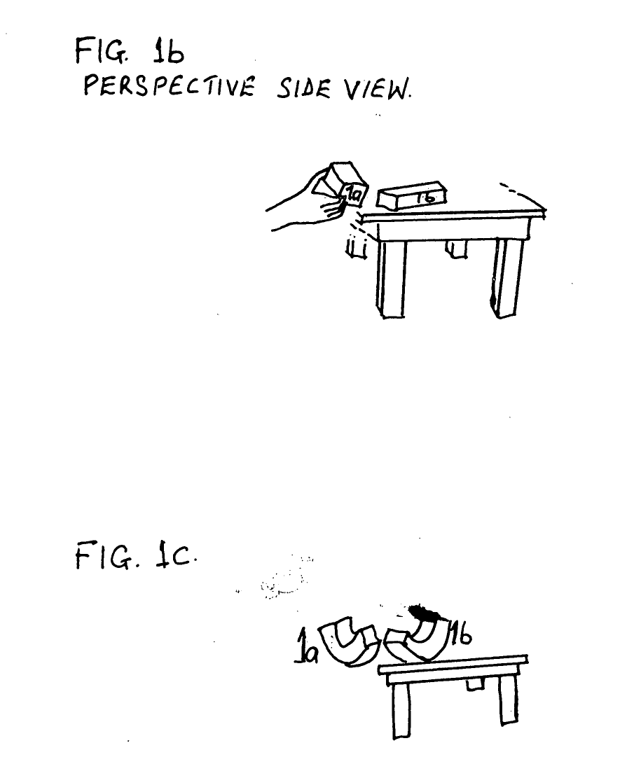

Here, in this application, I'm asserting a third, but I'll call the 3 of them characteristics or derived laws, because it's actually a single law manifesting itself in 3 ways, depending on which 2 terms are engaged with each other.
The 1^{st} says LIKE TERMS REPEL
The 2^{nd} says UNLIKE TERMS ATTRACT
Now I'm saying:—
ANGULAR TERMS ROTATE as the 3^{rd} . . . . FIG. 1.

It is this third characteristic that is applied to what I call, the INVENTION.

### 002. Diagramatic Illustrations of the Characteristics.

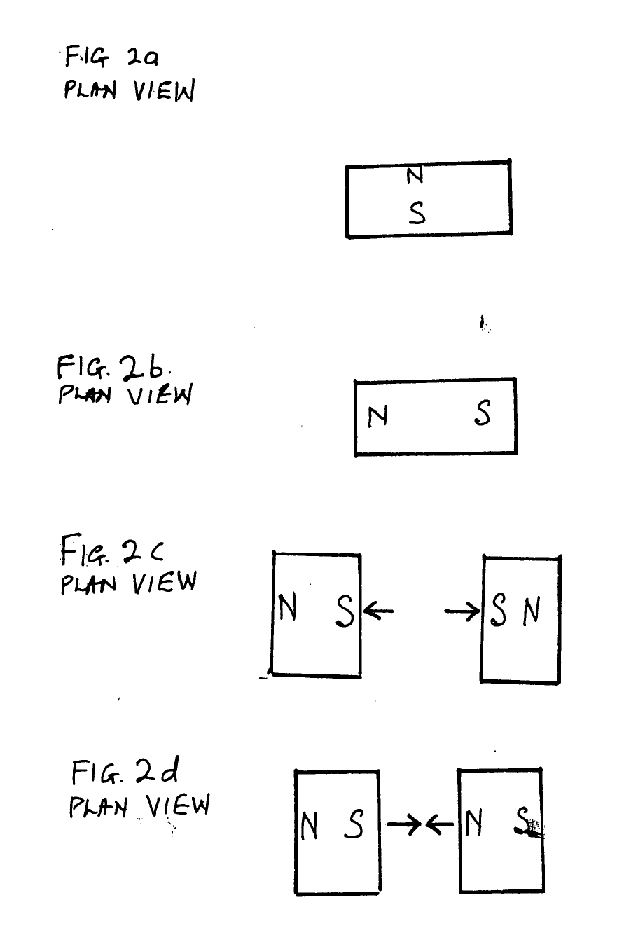

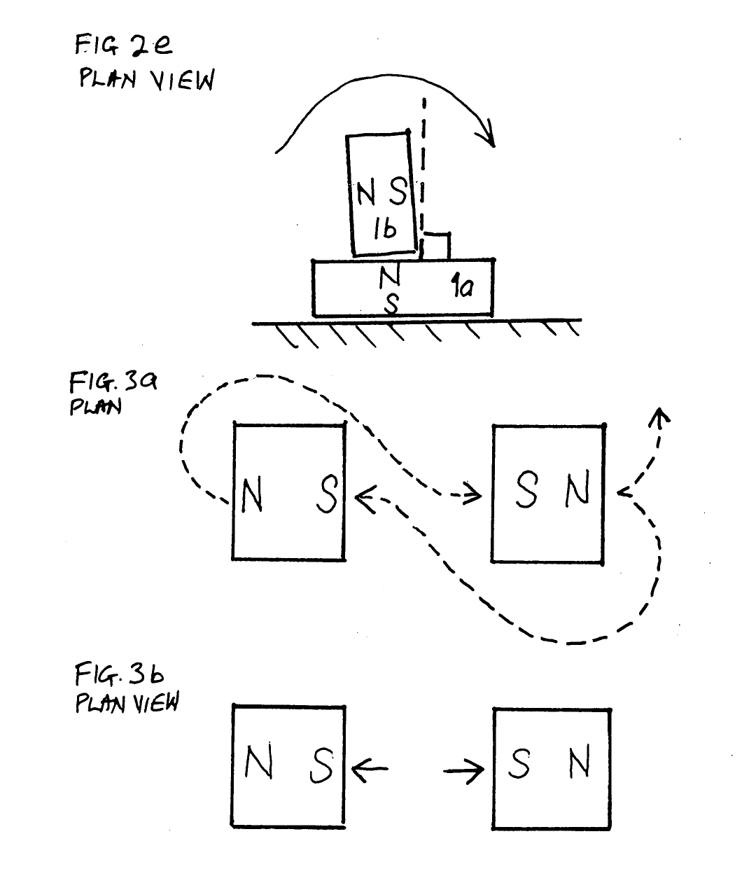

The magnet pieces to use for easier demonstration will have the following Orientation of polarities: —FIG. 2a rather than FIG. 2b.

The circular magnets behind speakers are Ideal if broken into 2, 3 or 4 pieces.

| | | |
|---|---|---|
| 1^{st} CHARACTERISTIC; | LIKE TERMS REPEL | FIG. 2c |
| 2^{nd} CHARACTERISTIC; | UNLIKE TERMS ATTRACT | FIG. 2d |
| 3^{rd} CHARACTERISTIC; | ANGULAR TERMS ROTATE | FIG. 2e |

All these 3 are however obeying 1 basic law that has been known in the study of Magnetic field, but never expressly stated as, THE LAW

### 003. The Law of Magnet

When 2 or more pieces of magnet are brought closer enough to form a common field, all the pieces STRIVE to REALIGN their terms in order to JOIN-UP into 1 single magnet.

### Exhibiting the Law in 1^{st} Characteristic

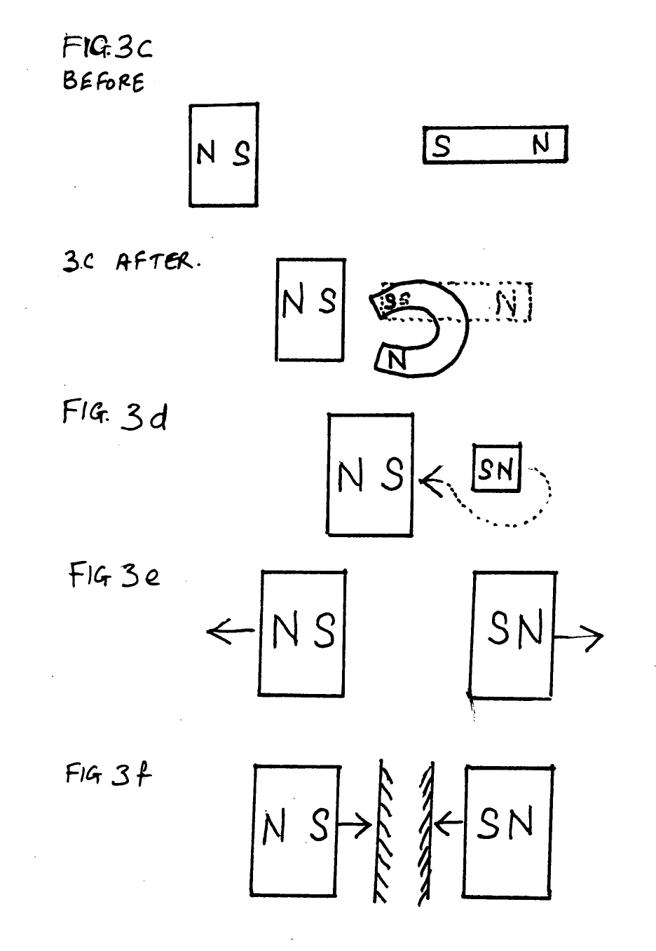

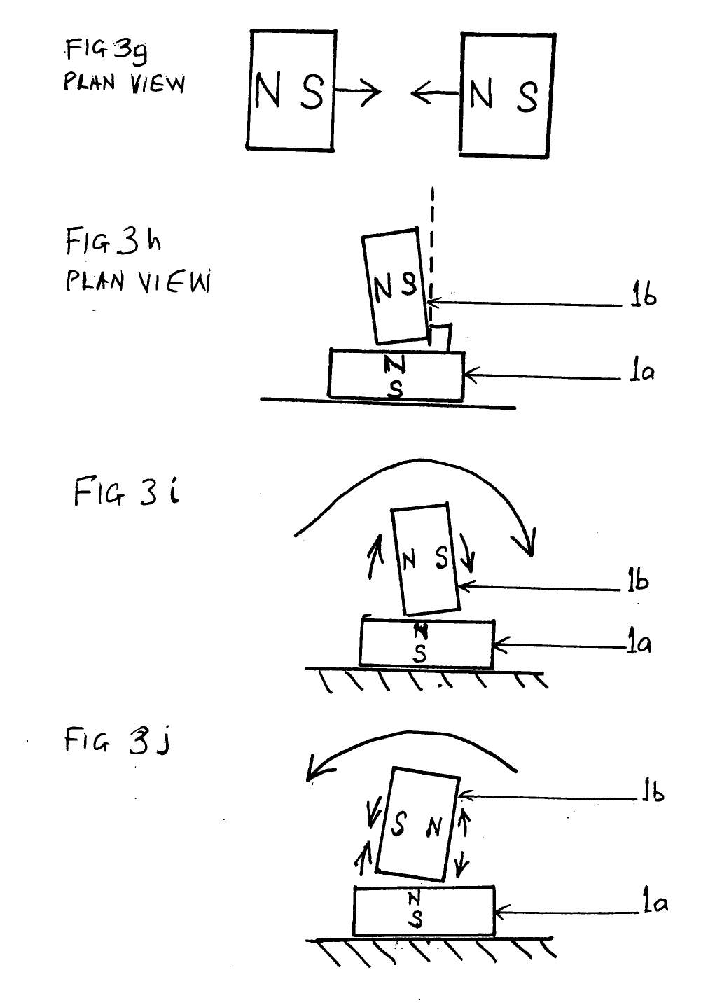

As a result of this law, when their positions as we have in FIG. 3a are like terms, it means they are not in a North to South or South to North alignment for joining-up. Therefore, they'll 1^{st} STRIVE to REALLIGN in order to JOIN together. The tendency of the N-pole of magnet2 to reach the S-pole of magnet1 i.e. STRIVING TO REALLIGN [in obedience to the law] is responsible for what makes it seem as if, their South poles are repelling. (FIG. 3b) It is actually an attraction at work, but between terms that are not in alignment, and first want to re-align. In other words, the repelling force is not independent. It is a dependent variable on the function of the attracting force. It is a dependent variable, a function of a factor. This factor is the attracting force. If there is no attraction, then, there will be no repelling. This attracting force is the SOLE force. If magnet pieces were flexible, rather than the south poles repelling, one north pole would have bent backwards like a U to join the south of the other. (see FIG. 3c.)

This is why (as I observed) the repelling force in like terms is not as strong as the force of attraction in unlike terms. If you now use a big magnet1 and a small magnet2, (See FIG. 3d) then, rather than repel [as the old law says], the 3^{rd} characteristic will occur. The N-pole at extreme right of magnet2 will vigorously rotate (i.e. STRIVE to ALLIGN) in order to JOIN together with magnet1's S-POLE, It means again, that an attraction was at work, It turned round by itself to form a Magnet [in obedience to the law]. I also observed that what we call repelling is less of a PUSHING-AWAY from each other, (FIG. 3e) and more of a RESISTANCE to pulling-together (FIG. 3f.)

### Exhibition of the Law in 2^{nd} Characteristic

Where the positions are unlike terms, [FIG. 3g], then the S-pole of magnet 1, so near to the N-pole of magnet2 will readily join up because, ALIGNMENT is in place already. The 2 poles that should join together to form a magnet are nearest to each other, therefore, very strongly, they STRIVE to JOIN together.

Therefore, while in the like terms arrangement of FIG. 3a, alignment is not in place, there's the need to realign in order to attract. However, in the unlike terms arrangement of FIG. 3g, alignment is already in place, they will just more readily attract to join-up.

### Exhibition of the Law in 3^{rd} Characteristic

Now when they are at an angle [near-perpendicular] as shown in FIG. 3h, where magnet2 tilts a little towards the like terms than the unlike terms, then when you hold magnet1 strongly and in a sudden thrust bring close to magnet2 to about ½ cm away for about ½ a second and quickly withdraw it, magnet2 rotates using its middle as fulcrum.

The near perpendicular position is more effective than a perfect 90 degrees position, perhaps due to the fact that the force of attraction is stronger than repelling, so if it were placed at exactly 90 degrees, spinning effects may be reduced by a direct attraction since it's stronger than the repelling.

If you observe the expected direction of movement according to the polarities of the magnet pieces in diagram 3i, you'll realize that while on the left hand side the N-poles of both magnets should cause magnet2 to turn clockwise in a repelling force [or resist attraction]. On the right-hand side, the attraction between the S-pole of magnet2 and N- of magnet1 should also cause magnet2 to turn clockwise. The combination of both forces results in the clockwise spin of the entire magnet2. If you reverse the polarity of magnet2, the direction of the spin changes too to anti-clockwise. (See FIG. 3j)

### 004. Application of 3^{rd} Characteristics to Create an Invention. (A Hand Demonstration)

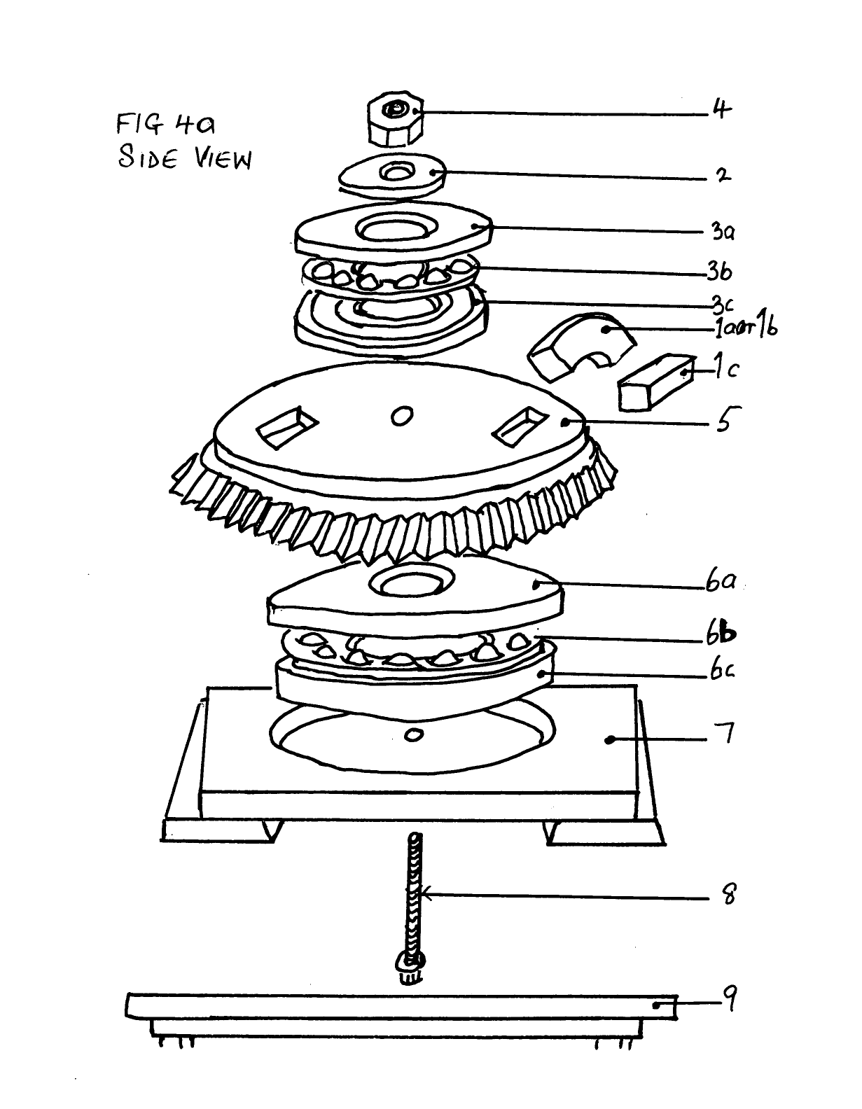

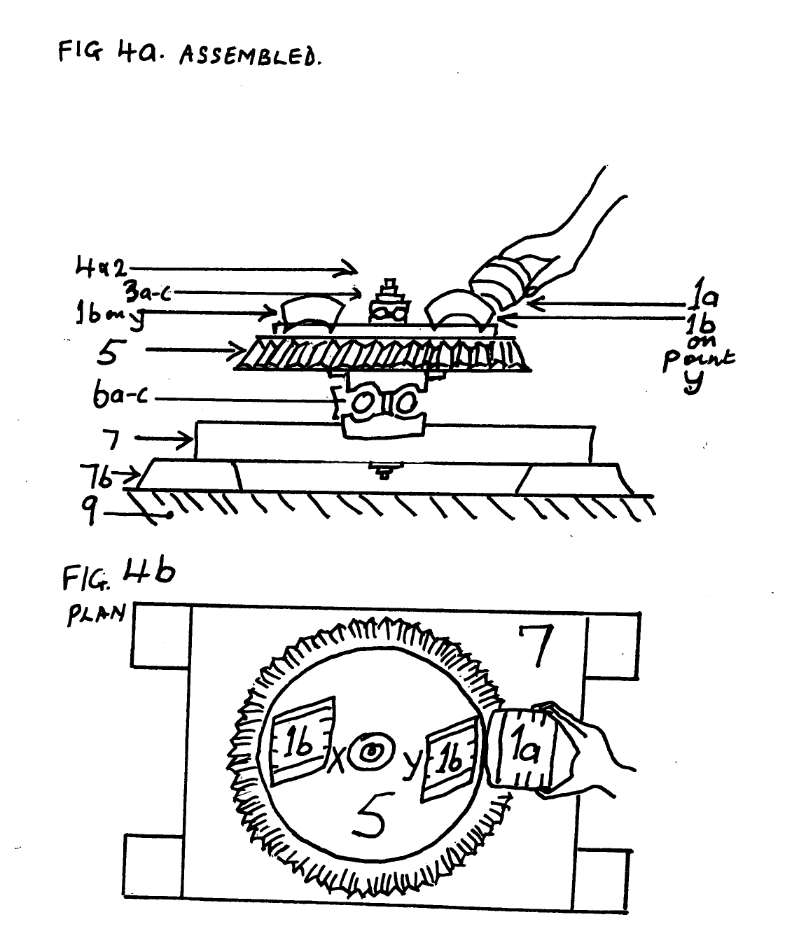

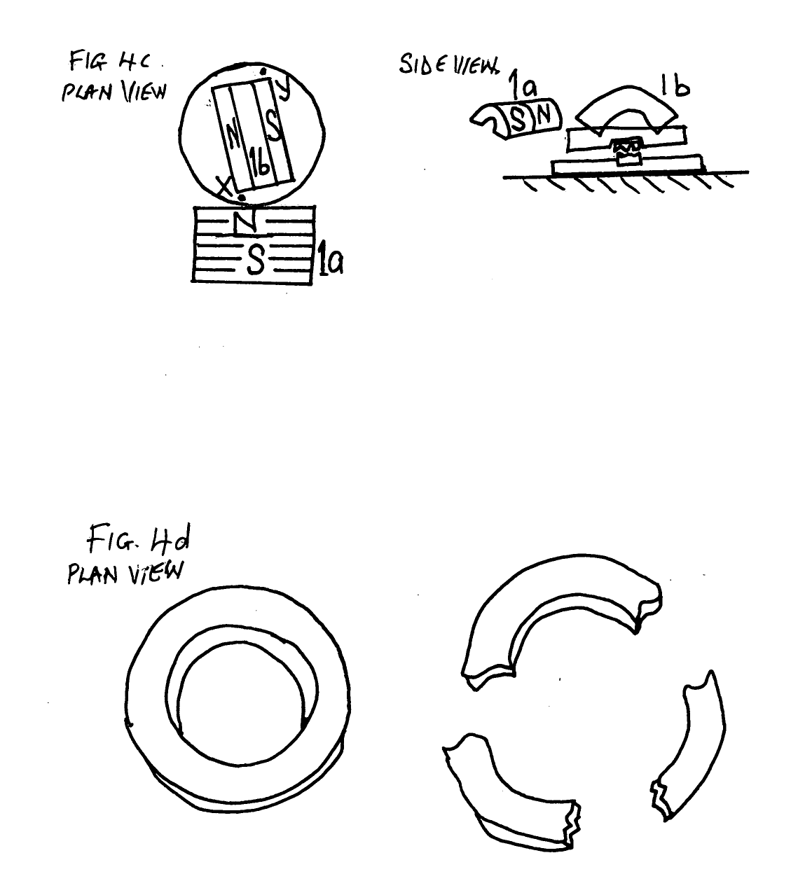

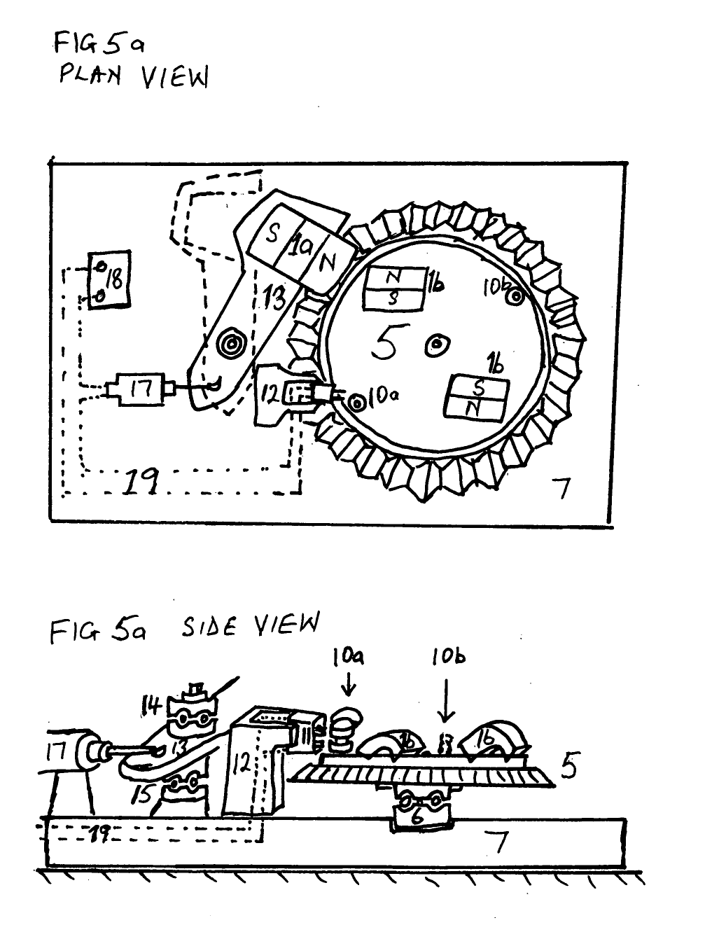

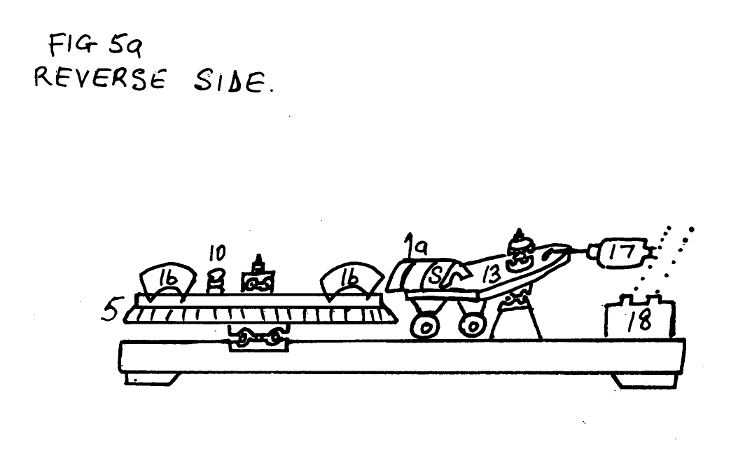

Arrange a wheel that can freely turn and place the magnet pieces as illustrated in FIGS. 4a, 4b and 4c. 1 set of magnet1 in hand and two sets of magnet2 glued or plastered to opposite points X and Y on the wheel. Each of both magnets on points X and Y must have the same N-S position when they turn to the hand held magnet1. The wheel could be about 30 cm to 45 cm in diameter but not too small to bring the magnet pieces on the wheel into a common field, except you have just one set of magnet2 on the wheel as in FIG. 4c.

FIG. 4d shows a sample of speaker magnet that is readily usable for illustration purposes. A magnet ring with a diameter of 10-15 cm can be broken into 2, 3 or 4 pieces. On points X, Y and magnet1, you may use 2 or 3 of such pieces for greater effect. The bigger the magnet(s) on the wheel, the stronger the wheel will be able, to push bigger loads of overcoming friction on turning gears and armature to attain required speed.

Secondly, (just as we saw in FIG. 3d) the bigger magnet1 in hand is than each of magnet2 on the wheel, the faster it will spin each of magnet2 and as well the wheel.

### 005. In Replacement of the Hand

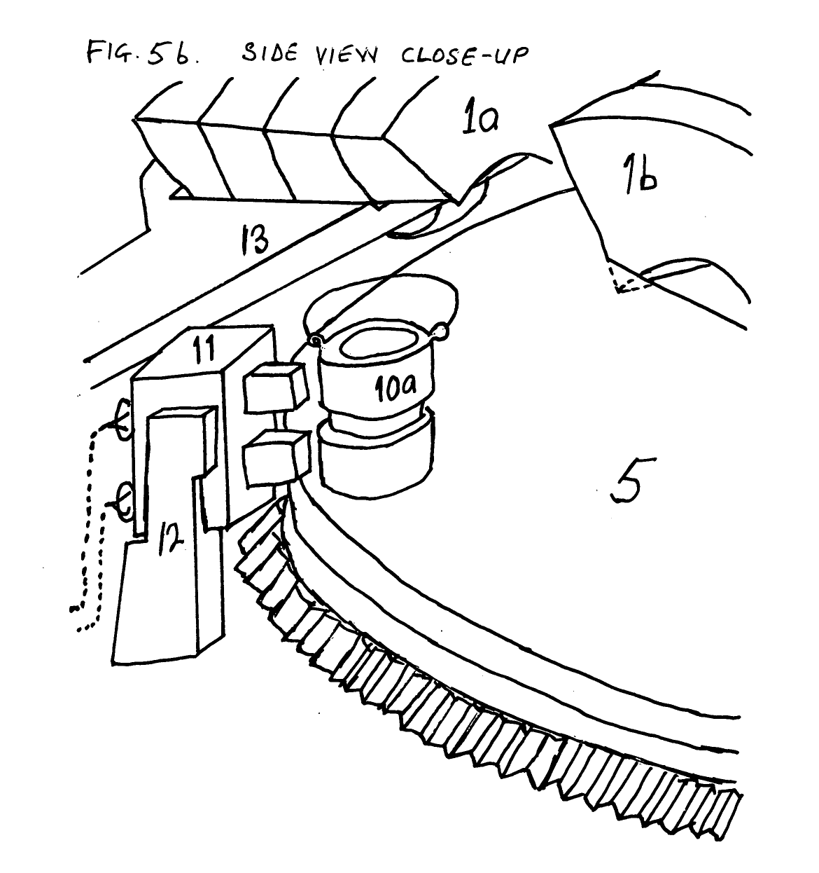

I replaced the hand with a light plywood lever [L] as shown in FIG. 5a. Triggered by an electromagnet [one can use the kick starter of a car for illustration purposes] where very little current from a small 12 volt battery, thrusts the lever back and forth when switched on and off by an open switch M. The point N on the wheel is timed to bridge the open switch M just when lever L should thrust forward to activate magnets in points X and Y on the wheel. The electromagnet (the type in a kick-starter) is combined with a spring returner.

FIG. 5b shows what you can use in the experiment. The brush of a small generating set as open switch M and a commutator each in points N1 and N2. Please note that the two terminals of the commutator are connected by a wire so it can close the circuit when it comes in contact with the brush.

### 006. How to Utilise the Invention to Generate Energy

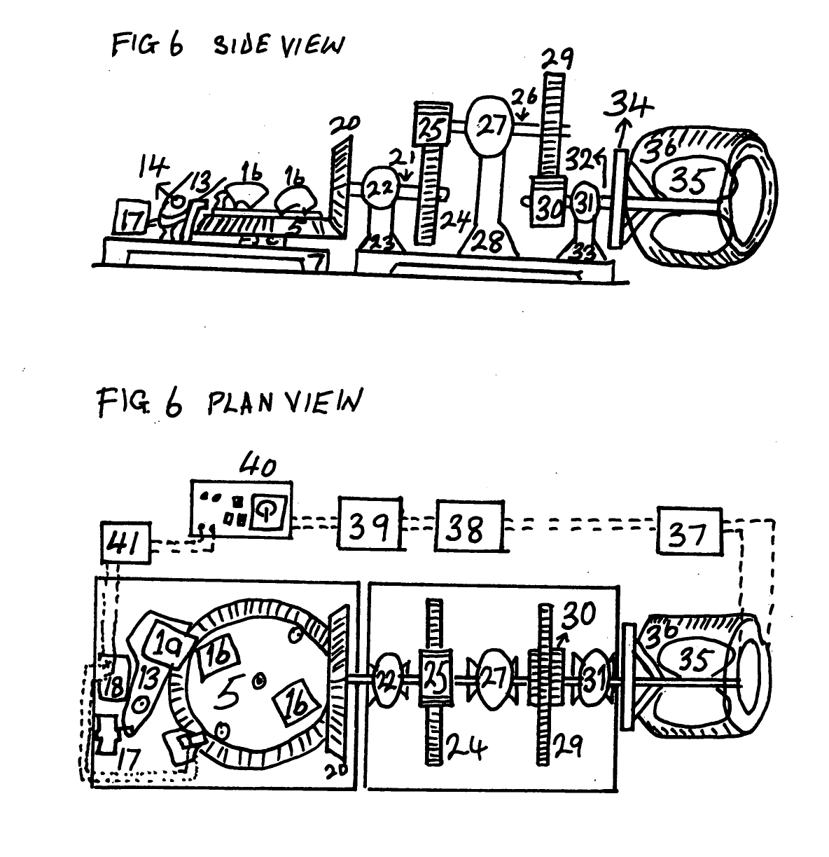

In FIG. 6a, the turning wheel is made to drive a set of reducing speed gear [in reverse arrangement to become increasing speed gears], the last of which is made to turn an armature inside a coil to generate electricity.

Part of the electricity generated is connected to a battery charger that continuously charges the battery. By this process, the battery is continually able to activate the electromagnet, which thrusts lever L forward and so, make spinning magnet2 to turn the wheel.

This wheel, on which the spinning two pieces of magnet2 are fixed, turns the set of gears that runs the armature inside a coil.

### ADVANTAGE AND INDUSTRIAL APPLICABILITY OF INVENTION

So, this way, energy is continually generated without having to fuel the device.

When this is developed and applied in producing electricity for homes, industries and vehicles, the trend of global warming too, will be stemmed.

### 007. One of Other Possible Utilisation

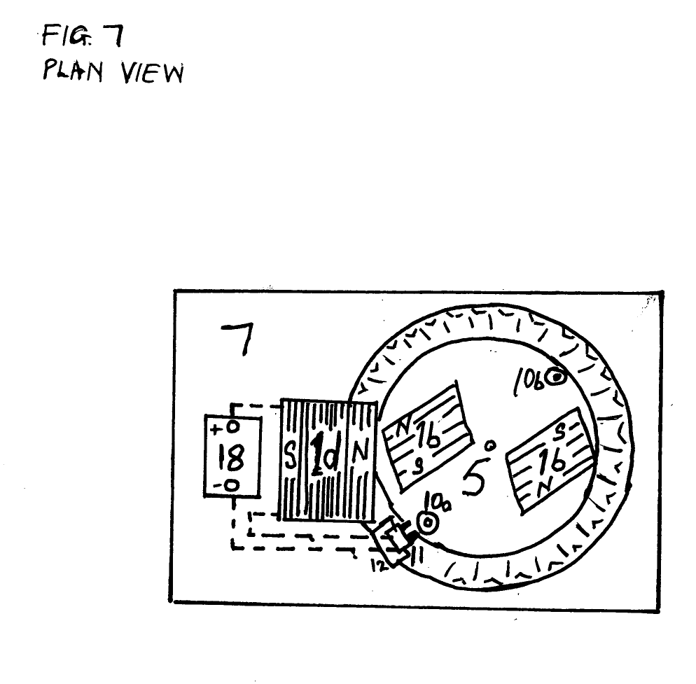

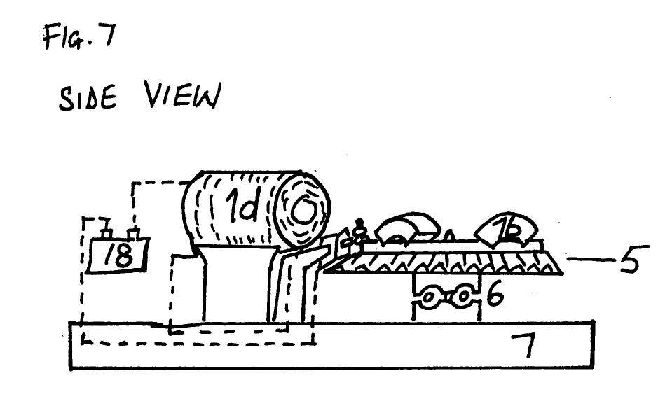

Instead of the hand held magnet, or the lever L that thrusts forward when an electromagnet is used, a bigger electromagnet may be directly used as magnet1 to spin a bigger magnet2 as shown in FIG. 7a.

### 008. Further Utilisation.

From FIGS. 2e, 3h and 3i, on the 3^{rd} characteristic of the magnet law, THEORETICALY, we can expect the following derivable operations. They are however subject to further developments.

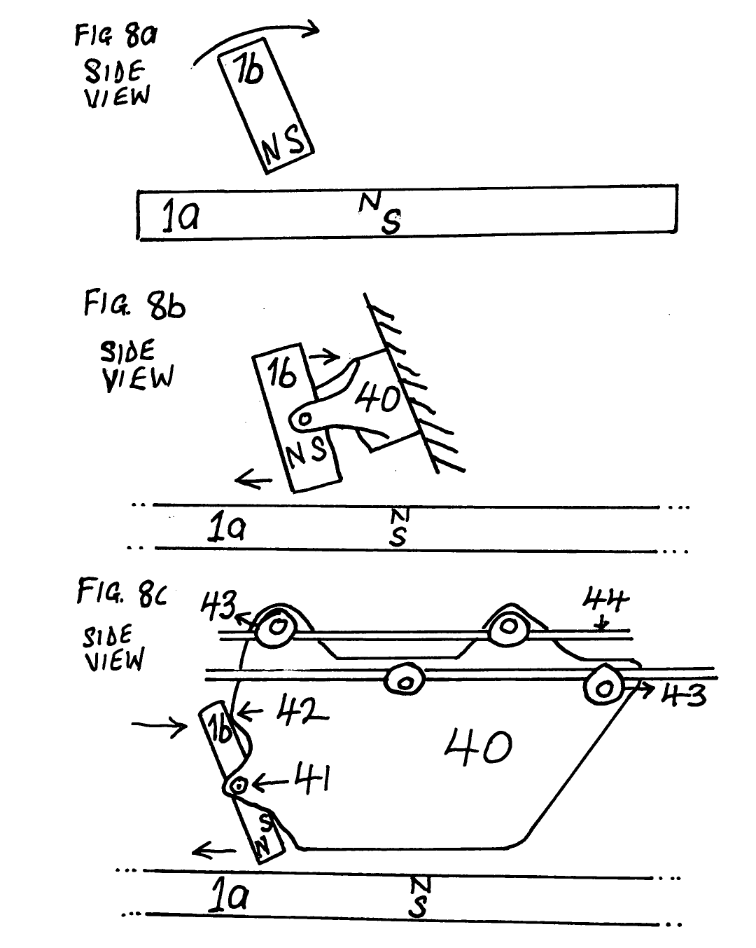

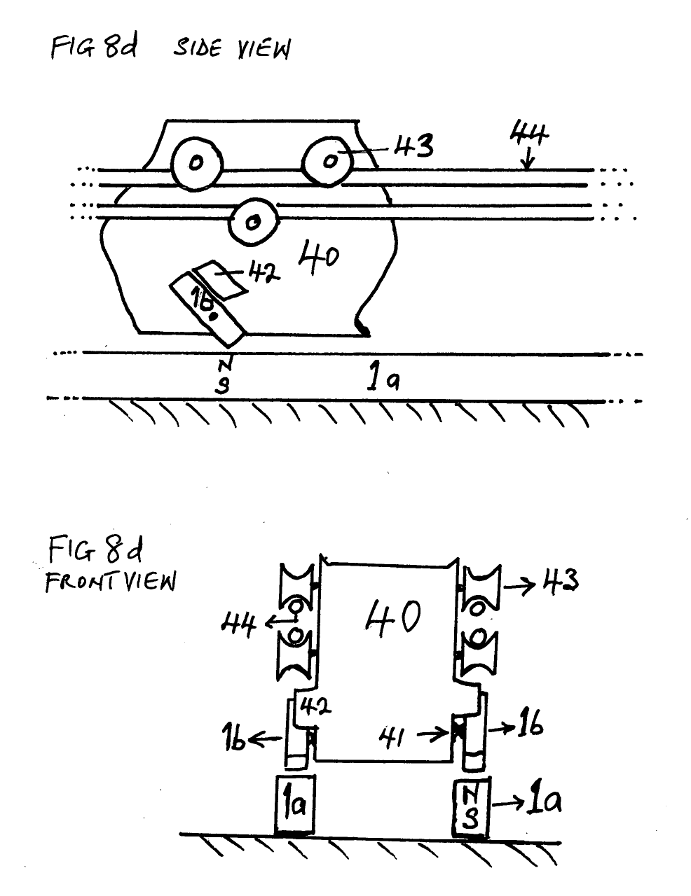

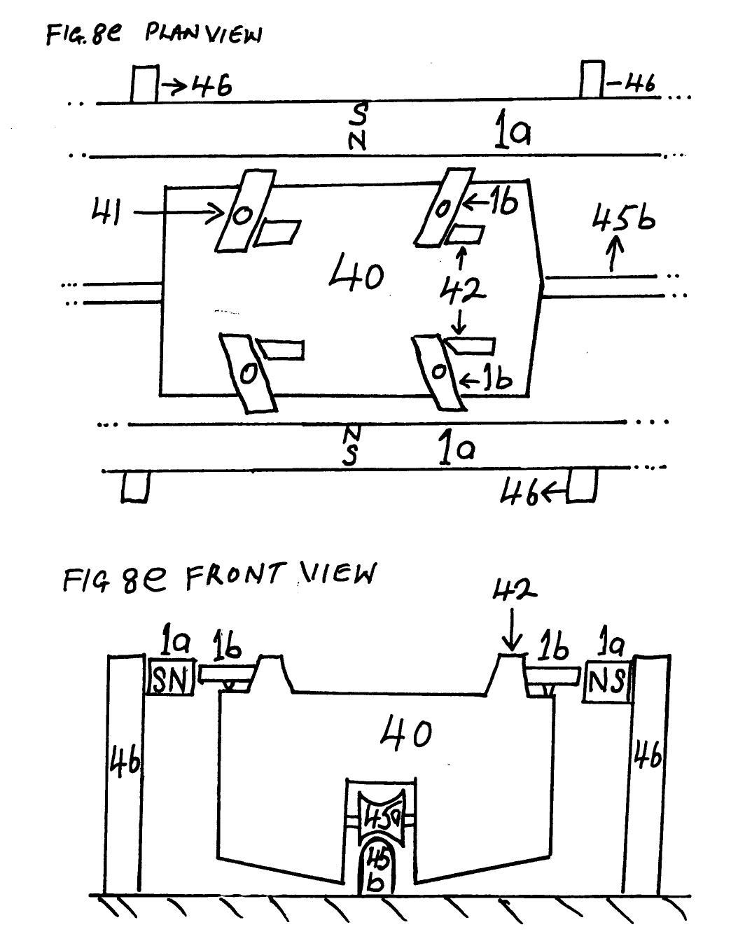

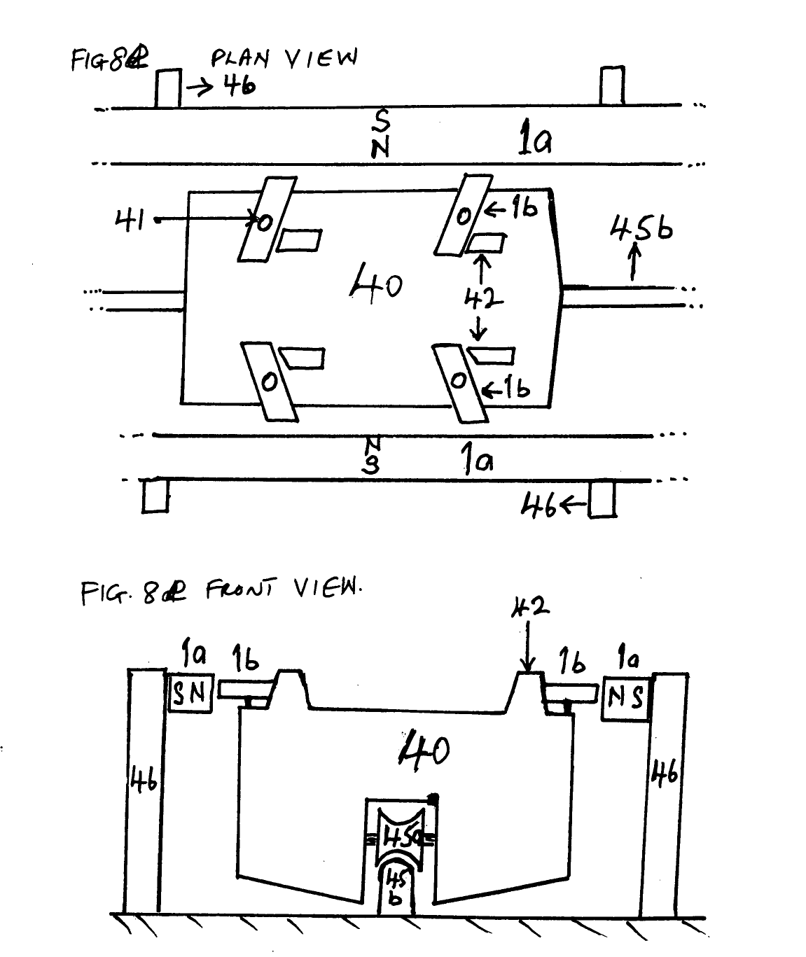

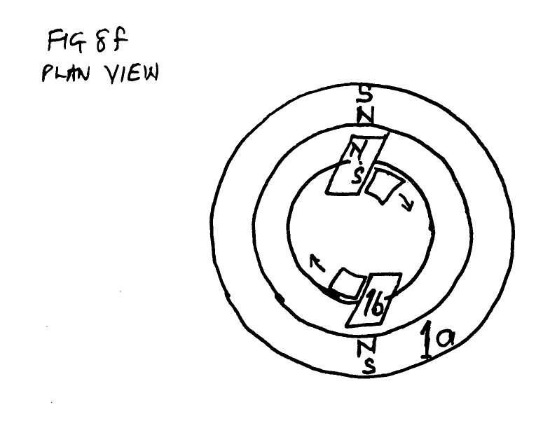

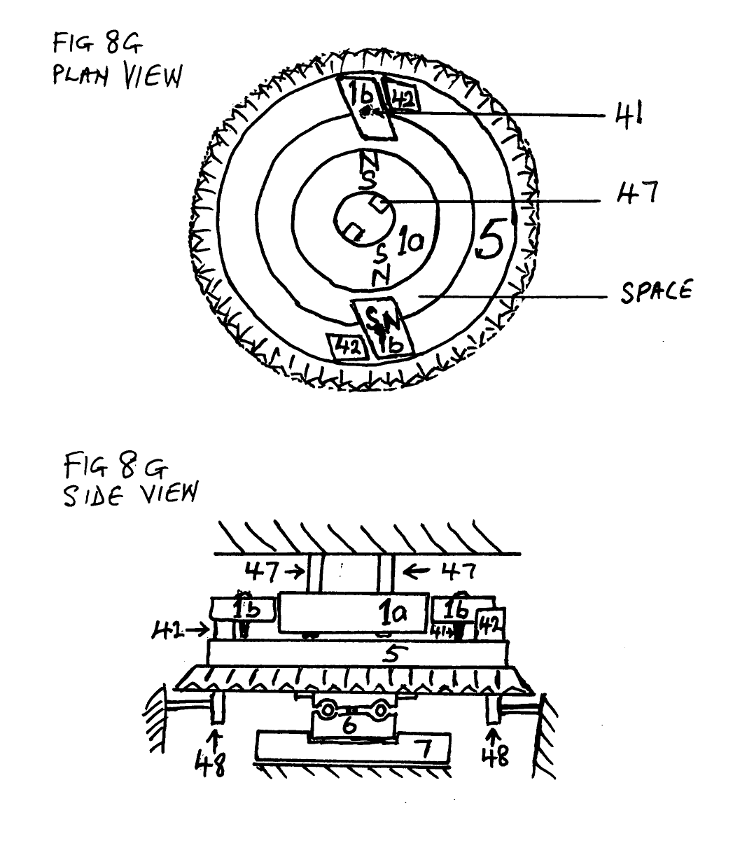

If we have a long magnet rail [MAGNET1] where the top layer has a polarity (say N-pole) and the lower, the S-pole. We now have a magnet piece [Magnet2] positioned at the beginning, we should expect it to spin clockwise (FIG. 8a). If one hinges the middle of magnet 2 to the back of a non magnetic body that's hanging on rollers, the upper part of MAG2 will spin to the right & lower part to the left. So, when it's not a circular but linear application, the 2 together won't work directly.

The upper right turn only, is applied to push the load to the right, while the middle of magnet2 is least in force. FIG. 8b.

In FIG. 8c, If magnet 2 in 1, 2, 3 or more places depending on the length or no. of a container (K) are now hinged in their midpoints to the left of a non-metallic container, that's freely hanging on rollers along the path of the rail [magnet1], then the clockwise spin of all the magnet2 pieces should be able to push the container forward along the path of the rollers.

Alternately, (see FIG. 8d) magnet2 may be freely hinged in its middle to the side of the container such that when it spins, it pushes against a side contour on the container to push (K) forward.

Again, as you'll notice in FIG. 8e, that rather than a bottom to top arrangement of magnet1 and magnet2, it could be outer side rails of magnet1 to inner side pieces of magnet2 on the container's outer side. All Magnet2 pieces must be apart enough to avoid any 2 from forming a common field.

A direct circular application of FIG. 8e is in FIG. 8f., but to avoid a counter force from point R of Magnet1 is difficult, so reversing the position of Magnet1 from outer ring to inner position will avoid R. as we have in FIG. 8g.

### 009. Much Further Utilisation

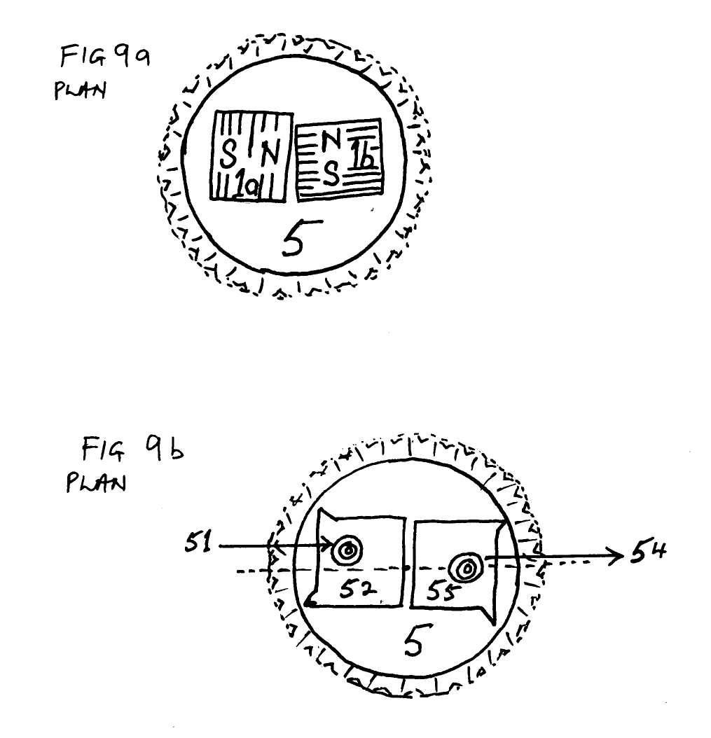

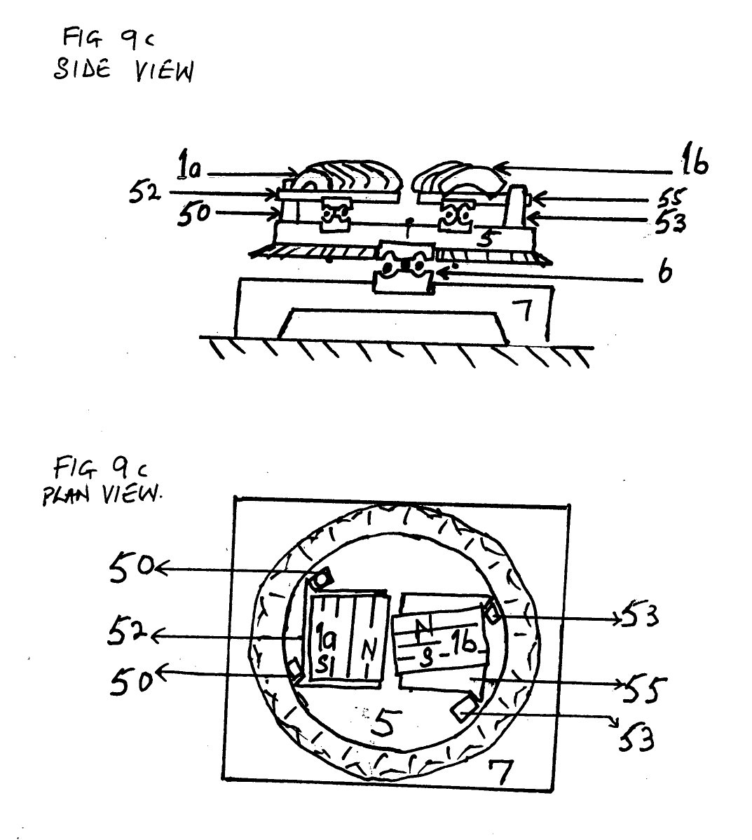

Again if the functions in FIGS. 2e, 3h, 3i and 8a should hold and are verified. It should follow then that according to FIG. 9a, without the use of any battery, motion can still be activated.

As usual there's a wheel (W) that can freely rotate on a fixed plank base. However, this time both magnets1 & 2 are not sitting on the wheel directly. They are on planks, Teflon or any non magnetic material. Plank P on the left and Q on the right which in turn have thrust bearings between the wheel and the planks that make them rotate freely. They are located on opposite sides on the top surface of the main wheel (W). As it obtains in 3^{rd} Characteristic, Plank P will carry magnet1 that was hitherto carried by hand while plank Q will carry magnet2. 4 to 5 pieces of magnet may be joined in each to attain greater effect as shown in FIG. 9a

In FIG. 9b, the locations of the bearings holding the planks to the top surface of the wheel are such that while plank Q′s bearing position is horizontally along the wheel's diameter; plank P′s bearing position is slightly above the diameter.

The reason for plank P′s bearing position is that, while Q will spin neatly around its middle only in a clockwise direction, P will both turn clockwise and slightly push backwards. This position of bearing will make P to only turn around its bearing and not against it.

Planks P and Q will have 2 protruding notches as shown in FIG. 9c TOP VIEW, that will immediately push against stoppers S1 and S2 in P's case, and T1 and T2 in Q's case. The combination of both should result in a clockwise movement of the entire wheel (W).

### 003. The Law of Magnet

When 2 or more pieces of magnet are brought closer enough to form a Common field, all the pieces STRIVE to REALIGN their terms in order to JOIN-UP into 1 single magnet.

### Exhibiting the law in 1^{St} Characteristic

As a result of this law, when their positions as we have in FIG. 3a are like terms, it means they are not in a North to South or South to North alignment for joining-up. Therefore, they'll 1^{st} STRIVE to REALLIGN in order to JOIN together. The tendency of the N-pole of magnet2 to reach the S-pole of magnet1 i.e STRIVING TO REALLIGN [in obedience to the law] is responsible for what makes it seem as if, their South poles are repelling. (FIG. 3b) It is actually an attraction at work, but between terms that are not in alignment, and first want to re-align. In other words, the repelling force is not independent. It is a dependent variable, a function of a factor. This factor is the attracting force. If there is no attraction, then, there will be no repelling. This attracting force is the SOLE force. If magnet pieces were flexible, rather than the south poles repelling, one north pole would have bent backwards like a U to join the south of the other. (see FIG. 3c.)

1. Beyond the 2 laws of magnet that were known to us, there's a third; that ANGULAR TERMS ROTATE; wherein the 2magnets in use [for a quick demonstration] have their NORTH and SOUTH polarities between their 2 sides along the length and not between their 2 ends across the breadth, and the first magnet [magnet1] held firmly in a horizontal position (plan view), is brought (say with its north pole side), to as close as ½ cm to an end of 2nd magnet [magnet 2], that's lying freely in a vertical position, perpendicular to the north pole side of magnet1, about 85 degrees to its own north pole (i.e. magnet1) and 95 degrees to its own south pole, (i.e. magnet 1).

2. When you apply claim 1 above to 2 different bodies, where magnet 2 is fixed firmly to the edge of a free moving body or free turning wheel, and magnet 1 is fixed firmly on another body that brings magnet 1 close to magnet 2 as illustrated in claim 1, the spin of magnet 2 will activate a pushing force on the body to which it is affixed.

3. The repetitive or continuous actions of claim 2 above, depending on the strength or type of the magnets in use, can be variously applied as desired, through a set of gear-wheels to increase speed, which in turn runs an armature inside a coil to generate electricity, or, if built powerfully enough, to directly accelerate the body on which magnet 2 is fixed.
